(19) United States
(12) Patent Application Publication
(10) Pub. No.: US 2026/0067350 A1
(43) Pub. Date: Mar. 5, 2026

(54) DEVICE REMOTE ACCESS CONTROL VIA WEBUSB

(71) Applicant: Lenovo (United States) Inc., Morrisville, NC (US)

(72) Inventors: Xueshi Wang, Cary, NC (US); Hassan Mahini, Cary, NC (US)

(21) Appl. No.: 18/823,290

(22) Filed: Sep. 3, 2024

(51) Int. Cl. H04L 67/025; G06F 13/38

(52) U.S. Cl. CPC H04L 67/025; G06F 13/385; G06F 2213/0042

(57) ABSTRACT

A computer implemented method includes instantiating a developer mode on a target device coupled via a USB cable to a local computer, establishing a connection between the local computer and a server via a portal on the local computer, establishing a connection between a remote computer and the server via a portal on the remote computer, wherein the server co-hosts sockets to the local computer and the remote computer, and providing access to manage the target device from the remote computer.

### BACKGROUND

Remote debugging tools for user computing devices require a user to install additional software, such as a driver. Additional setup may also be required on the personal computer. The use of WebUSB (universal serial bus) protocols solves many of the access and communication problems related to transferring data and execution of actions and command between a local computing system and a target device, such protocols have a limitation of being a local solution.

Local debug via Web Browser and WebUSB utilizes a local connection to a computing system via USB ports to target user computing devices. The need for a local connection is a problem for many IT administrators responsible for initiating and maintain larger deployments of user computing devices and requires multi-step configurations and more in-depth setting changes to the user computing devices that may be geographically distributed. Many times, end users with the user computing device in their position would lack the knowledge and expertise needed for the flow of changes that they can perform on their computing device required for continued operation satisfying required polices.

For a more advanced debugging, an IT (information technology) administrator needs access to device logs for troubleshooting and would need to execute custom ADB (Android® Debug Bridge) commands though execution of interactive shell functionality to further trouble shoot a specific process on the device. In the cases that an IT administrator wants to check and debug what's wrong with users'Android device, the administrator will ask a user to perform a series of actions and the user has to manually respond with the feedback. Often a user will be asked to use the command line interface to input commands and get logs from the system. These all require users to have a good understanding of the computing devices they are using and install additional software/driver such as Android® Debug Bridge. Many users are not comfortable with command line interfaces, and often it is the case that IT rules prevent users from installing software/drivers on their corporate machines.

Application and content updates may be needed in cases missing a crucial application or any special content on the device, IT administrator would need to use other method to share/send the new application or new content to the user first and then user will have to get them to be present on the local machine and then move forward with update.

Other remote debugging tools all require the user to install additional software/driver on the user computing device and perform additional setup.

### SUMMARY

A computer implemented method includes instantiating a developer mode on a target device coupled via a USB cable to a local computer, establishing a connection between the local computer and a server via a portal on the local computer, establishing a connection between a remote computer and the server via a portal on the remote computer, wherein the server co-hosts sockets to the local computer and the remote computer, and providing access to manage the target device from the remote computer.

### BRIEF DESCRIPTION OF THE DRAWINGS

FIG. 1 is a block diagram illustrating generally at 100, components involved in remotely managing devices according to an example embodiment.

FIG. 2 is a screen shot of an admin portal 200 running on the remote PC 135 prior to a target device being connected according to an example embodiment.

FIG. 3 is a screen shot of an admin portal in a connected state according to an example embodiment.

FIG. 4 is a screen shot of a user interface running on a browser on a local PC once the target device is connected via a USB cable according to an example embodiment.

FIG. 5 is a screen shot of a user portal interface on the local PC following selection of a connect option according to an example embodiment.

FIG. 6 is a screen shot illustrating the result of selecting Get UDC logs from the screen shot of the admin connected state according to an example embodiment.

FIG. 7 is a screen shot illustrating the result of selecting a version of the UDC app according to an example embodiment.

FIG. 8 illustrates results of entering the IP address of the target device in a command prompt line according to an example embodiment.

FIG. 9 is a screen shot illustrating the admin portal and screen access of the connected device according to an example embodiment.

FIG. 10 is a screen shot illustrating a prompt open on the remote PC with the admin having started to type “ifconfig” according to an example embodiment.

FIG. 11 is a screen shot illustrating the result of the admin having entered the text “ifconfig” resulting in a list of communication statistics according to an example embodiment.

FIG. 12 is a flowchart illustrating a computer implemented method of remotely managing target devices according to an example embodiment.

FIG. 13 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

An improved remote debugging method utilizes capabilities of an existing local user device, such as a personal computer having Chromium® browser based capabilities for remotely accessing managed local target devices. No additional software or user setup of the target device is required for performing a large range of remote debugging tasks.

Using WebUSB protocols available in all modern Chromium-based browsers and a WebADB library built on top of the browser, target devices, such as user wireless Android® based devices, can be seamlessly accessed and managed without the need for an additional software/driver to be loaded on the target devices. Remote access to target devices is provided via an extended environment using WebSockets connections defined in a backend server and a frontend webpage allowing real-time communication between frontend and backend. This added remote connection capability, further empowers users and IT administrators to access and manage target devices remotely from anywhere.

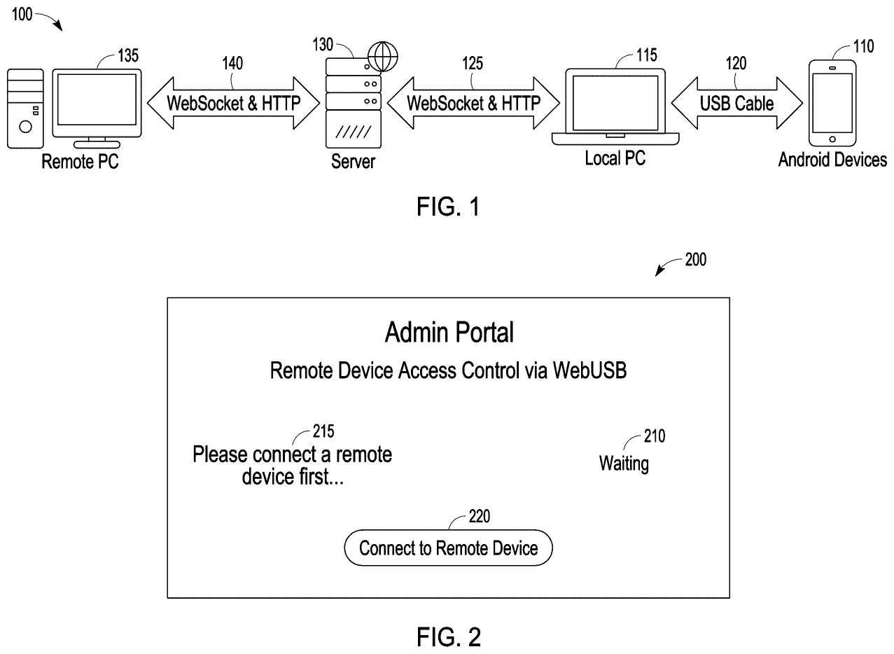

FIG. 1 is a block diagram illustrating generally at 100, components involved in remotely managing devices. In one example, a local user connects a target device 110 to local computer, such as a personal computer (PC) 115 via a USB cable 120 and turns on a developer mode on the target device 110. The local user then logs in to a portal on the local PC 115, to establish a connection 125 with a dedicated server 130, which may be remote server. A remote user such as an IT admin, logs in to the portal on a remote PC 135 and connects 140 to the server (co-hosting WebSocket and WebADB). The remote user takes active control of communicating with the target device 110 via an established WebSocket protocol with dedicated server 130. Once active control is established, the remote user can access and manage the target device 110 with the same level of capability and functionality that is available to the local user with direct access to the target device 110.

FIG. 2 is a screen shot of an admin portal 200 running on the remote PC 135 prior to a target device being connected. The portal displays “Waiting” 210 and includes an instruction to “Please connect a remote device first . . . ” 215. In portal 200, the “remote device” corresponds to target device 110. An option “Connect to Remote Device” 220 is also shown.

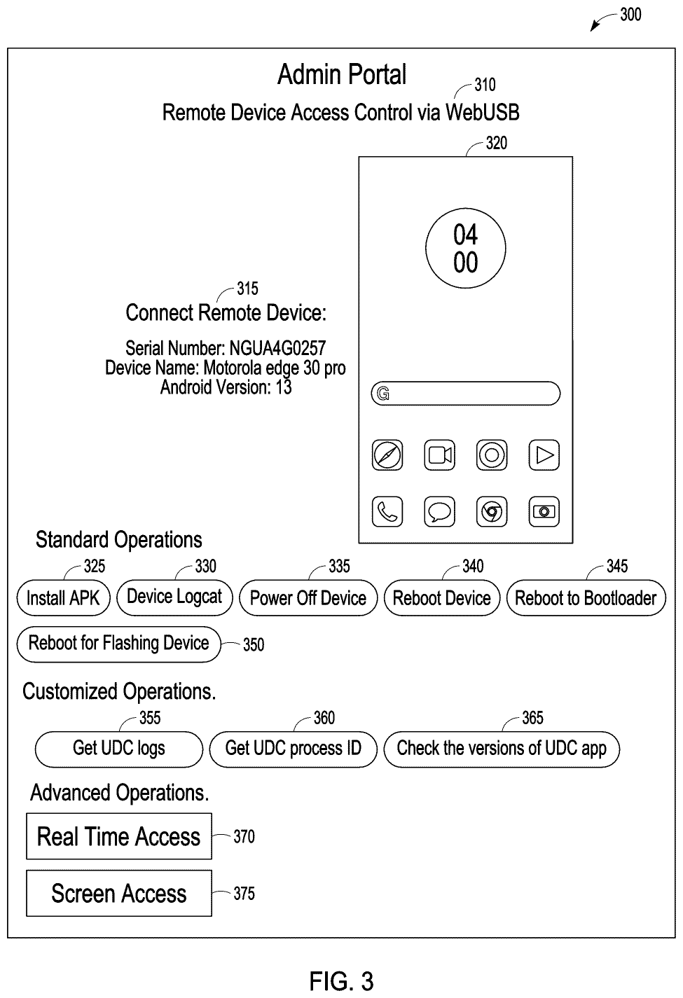

FIG. 3 is a screen shot of an admin portal in a connected state 300 resulting from selecting Connect to Remote Device 220. The connected state 300 provides an admin “Remote Device Access Control via WebUSB” 310. A connected indication 315 informs that the remote device is connected. A display 320 on a screen of the remote device is also shown, along with information about the remote device, such as a serial number, device name, and Android® version.

Several standard operations are shown providing management functions for the remote device, such as Install APK 325, Get Device Logcat 330, Power Off Device 335, Reboot Device 340, Reboot to Bootload 345, and Reboot for Flashing Device 350. Customized operations include “Get UDC logs 355, Get UDC process ID 360, and Check the version of UDC app 365. Advanced operations include Real Time Access 370 and Screen Access 375.

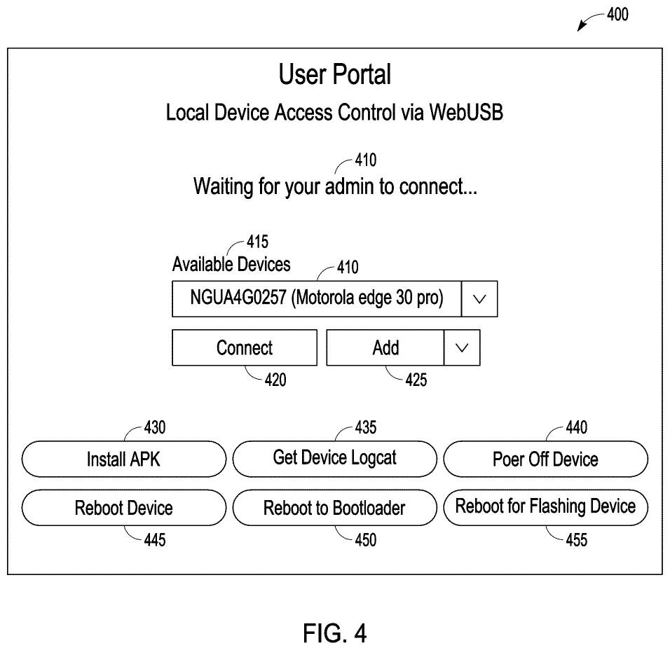

FIG. 4 is a screen shot of a user interface 400 running on a browser on local PC 115 once the target device 110 is connected via USB cable 120. Interface 400 provides local service access control via WebUSB. A first message indicates “waiting for your admin to connect . . . ” 410 and lists available devices 415 showing one such device at 417 “NGUA4G0257 (Motorola edge 30 pro)” along with a Connect option 420 and an Add option 425. Further options include Install APK 430, Get Device Logcat 435, Power Off Device 440, Reboot Device 445, Reboot to Bootloader, 450 and Reboot for Flashing Device 455.

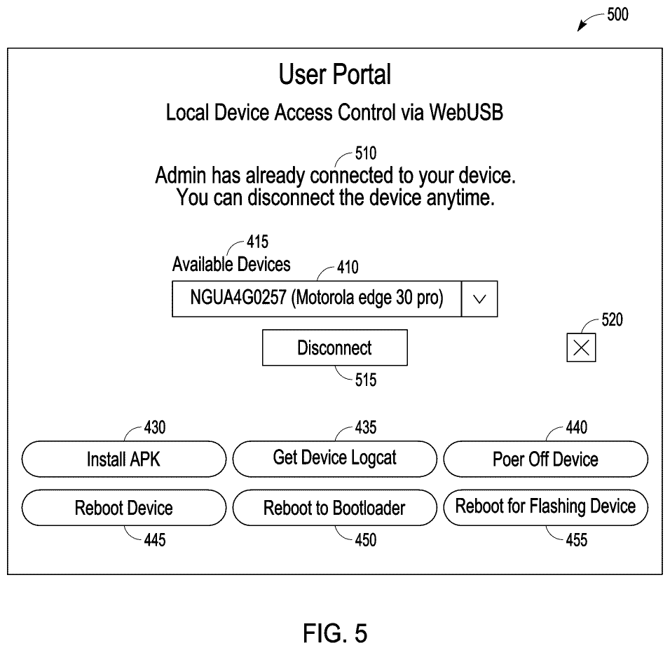

FIG. 5 is a screen shot 500 of user portal interface on the local PC 115 following the admin selecting Connect option 420. Screen shot 500 displays: “Admin has already connected to your device. You can disconnect the device anytime.” at 510 and showing a Disconnect selection 515. A checkbox 520 can be selected to exit the portal.

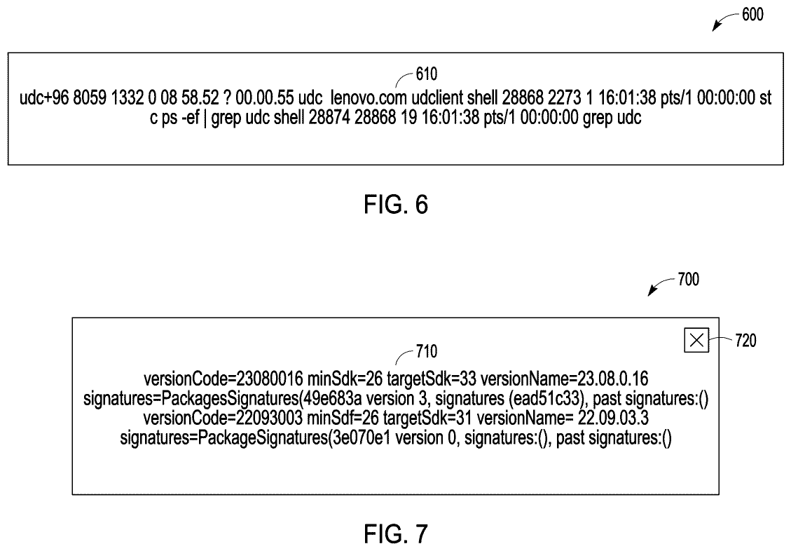

FIG. 6 is a screen shot 600 illustrating the result of selecting Get UDC logs 355 from screen shot of the admin connected state 300. UDC log 610 is shown showing the version of the connected device.

FIG. 7 is a screen shot 700 illustrating the result of selecting the version of the UDC app 365. Details of the version are shown at 710 and a checkbox 720 can be selected to exit the details.

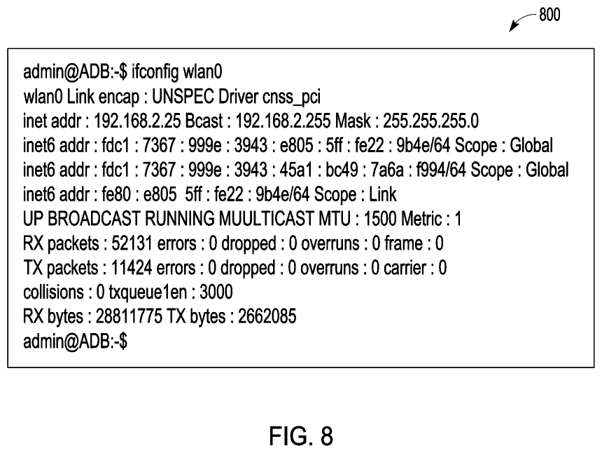

FIG. 8 illustrates results 800 of entering the IP address of the target device in a command prompt line.

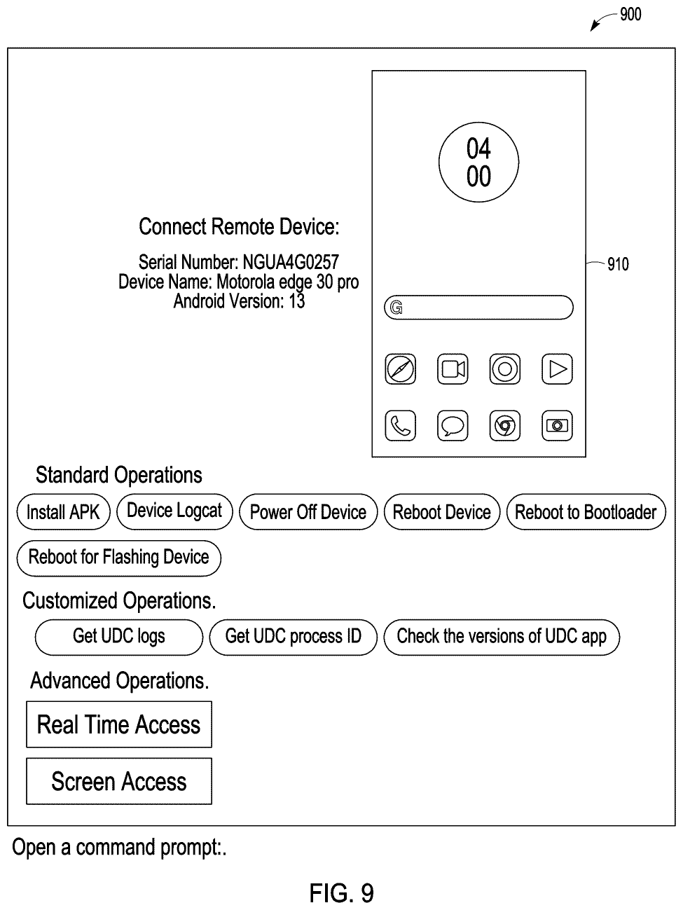

FIG. 9 is a screen shot 900 illustrating the admin portal and screen access of the connected device. The screen of the connected device is displayed at 910.

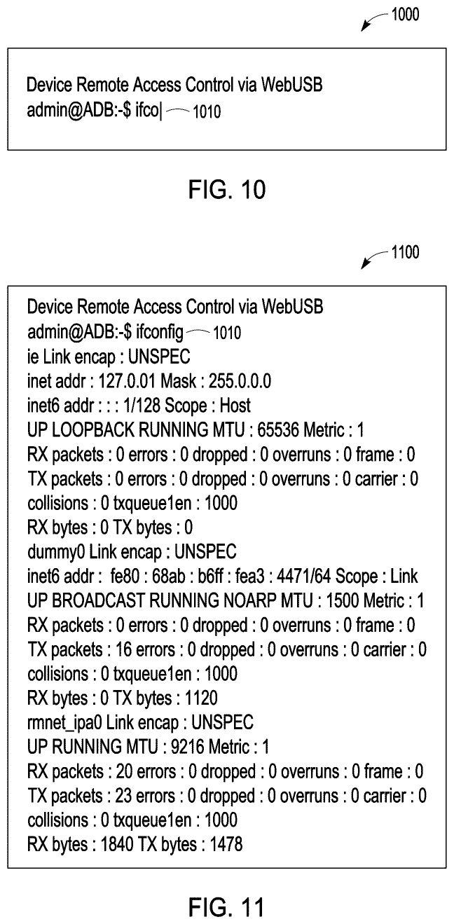

FIG. 10 is a screen shot 1000 illustrating a prompt open on the remote PC 135 with the admin having started to type “ifconfig” at 1010.

FIG. 11 is a screen shot 1100 illustrating the result of the admin having entered the text “ifconfig” at 1010 resulting in a list of communication statistics.

The screenshots shown were obtained from a remote PC 135 comprising a personal computer. The interfaces for remote access control can also be implemented on other devices, such as cellular phones and tablets in further examples.

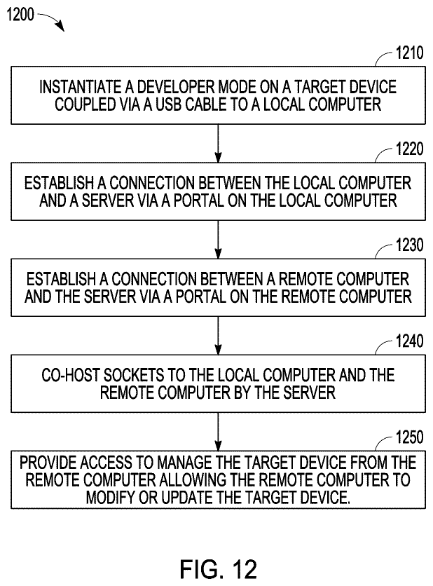

FIG. 12 is a flowchart illustrating a computer implemented method 1200 of remotely managing target devices. Method 1200 begins at operation 1210 by instantiating a developer mode on a target device coupled via a USB cable to a local computer. A connection is established at operation 1220 between the local computer and a server via a portal on the local computer. Operation 1230 establishes a connection, such as a connection implementing HTTP protocols, between a remote computer and the server via a portal on the remote computer. At operation 1240, the server co-hosts sockets to the local computer and the remote computer. The sockets may be WebSockets co-hosted by the remote server co-hosts the WebSockets.

Access to manage the target device from the remote computer is provided at operation 1250 allowing the remote computer to modify or update the target device.

In one example, the local computer establishes a debug bridge to the target device. The debug bridge may be an Android® debug bridge and the target device is an Android® based device.

The access provides a same level of access to functionality in the target device as a local user with direct access to the target device. The local computer includes a Chromium® based browser.

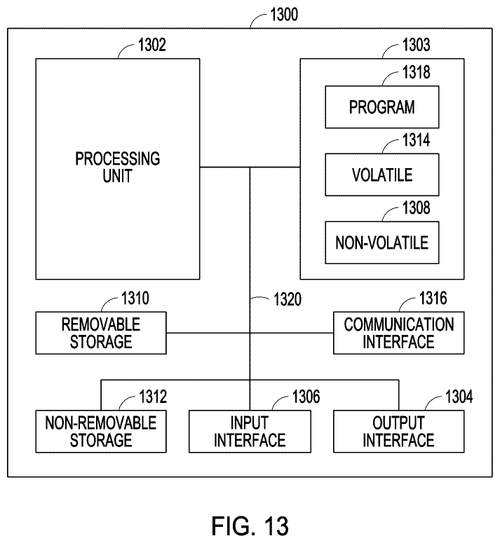

FIG. 13 is a block schematic diagram of a computer system 1300 to implement one or more devices involved in remote access control examples and for performing methods and algorithms according to example embodiments. All components need not be used in various embodiments.

One example computing device in the form of a computer 1300 may include a processing unit 1302, memory 1303, removable storage 1310, and non-removable storage 1312. Although the example computing device is illustrated and described as computer 1300, the computing device may be in different forms in different embodiments. For example, the computing device may instead be a smartphone, a tablet, smartwatch, smart storage device (SSD), or other computing device including the same or similar elements as illustrated and described with regard to FIG. 13. Devices, such as smartphones, tablets, and smartwatches, are generally collectively referred to as mobile devices or user equipment.

Although the various data storage elements are illustrated as part of the computer 1300, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 1303 may include volatile memory 1314 and non-volatile memory 1308. Computer 1300 may include - or have access to a computing environment that includes - a variety of computer-readable media, such as volatile memory 1314 and non-volatile memory 1308, removable storage 1310 and non-removable storage 1312. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 1300 may include or have access to a computing environment that includes input interface 1306, output interface 1304, and a communication interface 1316. Output interface 1304 may include a display device, such as a touchscreen, that also may serve as an input device. The input interface 1306 may include one or more of a touchscreen, touchpad, mouse, keyboard, camera, one or more device-specific buttons, one or more sensors integrated within or coupled via wired or wireless data connections to the computer 1300, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 1300 are connected with a system bus 1320.

Computer-readable instructions stored on a computer-readable medium are executable by the processing unit 1302 of the computer 1300, such as a program 1318. The program 1318 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 1318 along with the workspace manager 1322 may be used to cause processing unit 1302 to perform one or more methods or algorithms described herein.

### EXAMPLES

1. A computer implemented method includes instantiating a developer mode on a target device coupled via a USB cable to a local computer, establishing a connection between the local computer and a server via a portal on the local computer, establishing a connection between a remote computer and the server via a portal on the remote computer, wherein the server co-hosts sockets to the local computer and the remote computer, and providing access to manage the target device from the remote computer.
2. The method of example 1 wherein the local computer establishes a debug bridge to the target device.
3. The method of example 2 wherein the debug bridge comprises an Android® debug bridge and wherein the target device comprises an Android® based device.
4. The method of any of examples 1-3 wherein the sockets comprise WebSockets and wherein the remote server co-hosts the WebSockets.
5. The method of any of examples 1-4 wherein the connections to the server implement HTTP protocols.
6. The method of any of examples 1-5 wherein the access provides a same level of access to functionality in the target device as a local user with direct access to the target device.
7. The method of example 6 wherein the local computer includes a Chromium® based browser.
8. The method of any of examples 6-7 wherein the sockets are co-hosted by the remote server.
9. A machine-readable storage device having instructions for execution by a processor of a machine to cause the processor to perform operations to perform any of the methods of examples 1-8.
18. A device includes a processor and a memory device coupled to the processor and having a program stored thereon for execution by the processor to perform operations to perform any of the methods of examples 1-8.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
instantiating a developer mode on a target device coupled via a USB cable to a local computer;
establishing a connection between the local computer and a server via a portal on the local computer;
establishing a connection between a remote computer and the server via a portal on the remote computer, wherein the server co-hosts sockets to the local computer and the remote computer; and
providing access to manage the target device from the remote computer.

2. The method of claim 1 wherein the local computer establishes a debug bridge to the target device.

3. The method of claim 2 wherein the debug bridge comprises an Android® debug bridge and wherein the target device comprises an Android® based device.

4. The method of claim 1 wherein the sockets comprise WebSockets and wherein the remote server co-hosts the WebSockets.

5. The method of claim 1 wherein the connections to the server implement HTTP protocols.

6. The method of claim 1 wherein the access provides a same level of access to functionality in the target device as a local user with direct access to the target device.

7. The method of claim 6 wherein the local computer includes a Chromium® based browser.

8. The method of claim 6 wherein the sockets are co-hosted by the remote server.

9. A machine-readable storage device having instructions for execution by a processor of a machine to cause the processor to perform operations to perform a method, the operations comprising:
instantiating a developer mode on a target device coupled via a USB cable to a local computer;
establishing a connection between the local computer and a server via a portal on the local computer;
establishing a connection between a remote computer and the server via a portal on the remote computer, wherein the server co-hosts sockets to the local computer and the remote computer; and
providing access to manage the target device from the remote computer.

10. The device of claim 9 wherein the local computer establishes a debug bridge to the target device.

11. The device of claim 10 wherein the debug bridge comprises an Android® debug bridge and wherein the target device comprises an Android® based device.

12. The device of claim 9 wherein the sockets comprise WebSockets.

13. The device of claim 12 wherein the remote server co-hosts the WebSockets.

14. The device of claim 9 wherein the connections to the server implement HTTP protocols.

15. The device of claim 9 wherein the access provides a same level of access to functionality in the target device as a local user with direct access to the target device.

16. The device of claim 15 wherein the local computer includes a Chromium® based operating system.

17. The device of claim 15 wherein the sockets are co-hosted by the remote server.

18. A device comprising:
a processor; and
a memory device coupled to the processor and having a program stored thereon for execution by the processor to perform operations comprising:
instantiating a developer mode on a target device coupled via a USB cable to a local computer;
establishing a connection between the local computer and a server via a portal on the local computer;
establishing a connection between a remote computer and the server via a portal on the remote computer, wherein the server co-hosts sockets to the local computer and the remote computer; and
providing access to manage the target device from the remote computer.

19. The device of claim 9 wherein the local computer establishes an Android® debug bridge and wherein the target device comprises an Android® based device.

20. The device of claim 9 wherein the sockets comprise WebSockets, wherein the remote server co-hosts the WebSockets, and wherein the connections to the server implement HTTP protocols.
